(19) United States
(12) Patent Application Publication
(10) Pub. No.: US 2025/0102368 A1
(43) Pub. Date: Mar. 27, 2025

(54) TEMPERATURE MEASUREMENT SYSTEM IMPROVEMENTS

(71) Applicant: Rosemount Inc., Shakopee, MN (US)

(72) Inventor: Prasad Ashok DIXIT, Pune (IN)

(21) Appl. No.: 18/652,270

(22) Filed: May 1, 2024

Related U.S. Application Data
(63) Continuation of application No. PCT/IB2023/061630, filed on Nov. 17, 2023.

(30) Foreign Application Priority Data
Sep. 26, 2023 (IN) 202321064495

(51) Int. Cl. G01K 1/14; G01K 1/02; G01K 1/024; G01K 1/08

(52) U.S. Cl. CPC G01K 1/14; G01K 1/024; G01K 1/026; G01K 1/08

(57) ABSTRACT

A thermowell includes a process mount and a cylindrical member. The process mount is configured to mount to a process intrusion. The cylindrical member is configured to be exposed to a process fluid and includes a plurality of bores extending therein. Each bore is configured to receive a separate temperature sensor assembly. A redundant process fluid temperature measurement system is also provided.

### CROSS-REFERENCE TO RELATED APPLICATION

This application is a continuation application filed under 35 U.S.C. 111 (a) and claims benefit of International Application No. PCT/IB2023/061630, filed Nov. 17, 2023, the content of which is hereby incorporated by reference in its entirety.

### BACKGROUND

The process industry employs process variable transmitters to monitor process variables associated with substances such as solids, slurries, liquids, vapors, and gases in chemical, pulp, petroleum, pharmaceutical, food and other fluid process plants. Process variables include pressure, temperature, flow, level, turbidity, density, concentration, chemical composition, and other properties.

A temperature transmitter provides an output related to a process fluid temperature. The temperature transmitter output can be communicated over a process control loop to a control room, or the output can be communicated to another process device such that the process can be monitored and controlled.

Some temperature transmitters are used with thermowells which are mounted to a pipe flange or process intrusion and are configured to receive a temperature sensor assembly or probe. The temperature sensor assembly is placed in thermal communication with a process fluid but is otherwise protected from direct contact with the process fluid. The thermowell is positioned within the process fluid in order to ensure substantial thermal contact between the process fluid and the temperature sensor assembly disposed inside the thermowell. Thermowells are typically designed using relatively robust metal structures such that the thermowell can withstand a number of challenges provided by the process fluid. Such challenges can include physical challenges, such as process fluid flowing past the thermowell at a relatively high rate; thermal challenges, such as extremely high temperature; pressure challenges, such as the process fluid being conveyed or stored at a high pressure; and chemical challenges, such as those provided by a caustic process fluid.

Thermowells can present challenges for process installations. Generally, each thermowell requires a process intrusion where the thermowell is mounted to and extends into a process vessel such as a tank or pipe. This process intrusion itself must be carefully designed and controlled such that the process fluid does not leak from the vessel at the intrusion point.

Many process industry operations require continuous measurement and control of several process parameters. These parameters may vary depending on the process. Temperature, however, is typically an important parameter to a number of processes. Accurate, continuous, and redundant temperature measurement are important for operator/operation safety, product quality, and process efficiency. In order to provide uninterrupted temperature measurement, some applications may require redundancy. Such redundancy is typically provided in the form of multiple process intrusions, thermowells, and even temperature transmitters. Accordingly, when required, process measurement redundancy can be achieved, but with considerable expense. Further, multiple process intrusions increase the risk of process fluid leaks.

### SUMMARY

A thermowell includes a process mount and a cylindrical member. The process mount is configured to mount to a process intrusion. The cylindrical member is configured to be exposed to a process fluid and includes a plurality of bores extending therein. Each bore is configured to receive a separate temperature sensor assembly. A redundant process fluid temperature measurement system is also provided.

### BRIEF DESCRIPTION OF THE DRAWINGS

FIG. 1 is a diagrammatic view of triple redundant temperature measurement system in accordance with the prior art.

FIG. 2 is a diagrammatic view of a triple redundant process temperature sensing system in accordance with an embodiment of the present invention.

FIG. 3 is a block diagram of an improved process temperature measurement system in accordance with an embodiment of the present invention.

FIG. 4 is a diagrammatic cross-sectional view of an improved thermowell in accordance with an embodiment of the present invention.

FIG. 5 is a diagrammatic cross-sectional view of a triple redundant temperature sensor thermowell assembly in accordance with an embodiment of the present invention.

FIGS. 6A-6F show various top plan views of a cylindrical member configured to receive a plurality of temperature sensor assembly in a thermowell in accordance with embodiments described herein.

FIG. 7A is a diagrammatic view of an improved terminal block in accordance with an embodiment of the present invention.

FIGS. 7B-7E show various design alignments between a thermowell cylindrical member and bores for receiving temperature sensor assemblies in accordance with embodiments described herein.

FIGS. 8A and 8B are diagrammatic top views illustrating an improved enclosure in accordance with an embodiment of the present invention.

FIG. 9 is a diagrammatic view of logic for measurement of multiple process fluid temperature values using multiple temperature sensor assemblies in accordance with an embodiment of the present invention.

FIG. 10 is a logic diagram of voting logic of a safety instrumented system.

### DETAILED DESCRIPTION OF ILLUSTRATIVE EMBODIMENTS

RTDs and thermocouples are examples of temperature sensitive elements that are widely used in the industry for temperature measurement. These temperature sensitive elements are generally placed in a metal sheath to provide a temperature sensor assembly. The temperature sensor assembly is often placed inside a thermowell. Thermowells are inserted into the process fluid using a process intrusion created on the process equipment or pipeline. Thermowells generally include a flanged or threaded process connection which is fixed to the process intrusion. Temperature sensor assemblies can be electrically connected directly to a process control system, or they can be connected through temperature transmitters. As used herein, a temperature sensor assembly includes a temperature sensitive element, such as a thermocouple or RTD as well as a metallic sheath containing the temperature sensor element. An insulative material such as mineral insulation or epoxy is generally used to secure the temperature sensitive element within the metallic sheath. The temperature sensor assembly is generally cylindrical in nature and is received by a cylindrical bore within the thermowell. While direct connection requires special cables for thermocouples and multicore (three or four) conductors for RTDs, connection via temperature transmitters offers advantages over connecting the temperature sensor assemblies directly.

Each thermowell can generally accommodate a single temperature sensor assembly. A limitation of current thermowells is that each thermowell requires a separate process intrusion on the process equipment. If the process application requires triple redundancy at the measurement level, then three distinct process intrusions need to be created on the process equipment. While an option for dual sensors is available, in this arrangement there are two sensors packed in a single sheath. The dual sensors can be connected independently to the system and used as two separate elements. However, due to advantages offered by temperature transmitters, connection via temperature transmitters is preferred. Currently, temperature transmitters only offer one output signal for a dual sensor arrangement. As a result, effectively one sensor per process intrusion is used at a time and multiple sensor assemblies and their associated thermowells are generally needed depending on end user redundancy requirements.

Current techniques for redundant process temperature measurement are somewhat limited. For example, the cost of fabrication increases due to the requirement of multiple process intrusions, one for each thermowell. Maintenance costs also increase. Additionally, temperature cannot be measured exactly at the same point as there is a distance between the multiple process intrusions. Further, inline flowmeters may require a certain length of straight obstruction-less pipe on the upstream side as well as the downstream side. Providing thermowells on the upstream side of the flowmeter increases the length. Another limitation with current techniques is that end users may have to spend considerably more (2×-3×) for redundant temperature measurement (the cost of multiple thermowells and temperature elements). Finally, in the example of dual sensors, if any of the sensors in the dual sensor system fails, then the entire temperature sensor assembly requires replacement as both elements are packed in a single sheath and individual sensors cannot be replaced.

Embodiments described below generally improve upon thermowell design to accommodate a plurality (e.g., two, three, or more) temperature sensor assemblies instead of a single temperature sensor assembly. Another aspect of embodiments disclosed herein is an improved terminal block design which will allow replacement of each temperature sensor assembly separately. It is believed that embodiments described below will provide cost savings as the redundant temperature measurement installation can be performed in a single process intrusion and the overall cost of the redundant process temperature measurement system will be less than that as compared to the cost of multiple units being procured.

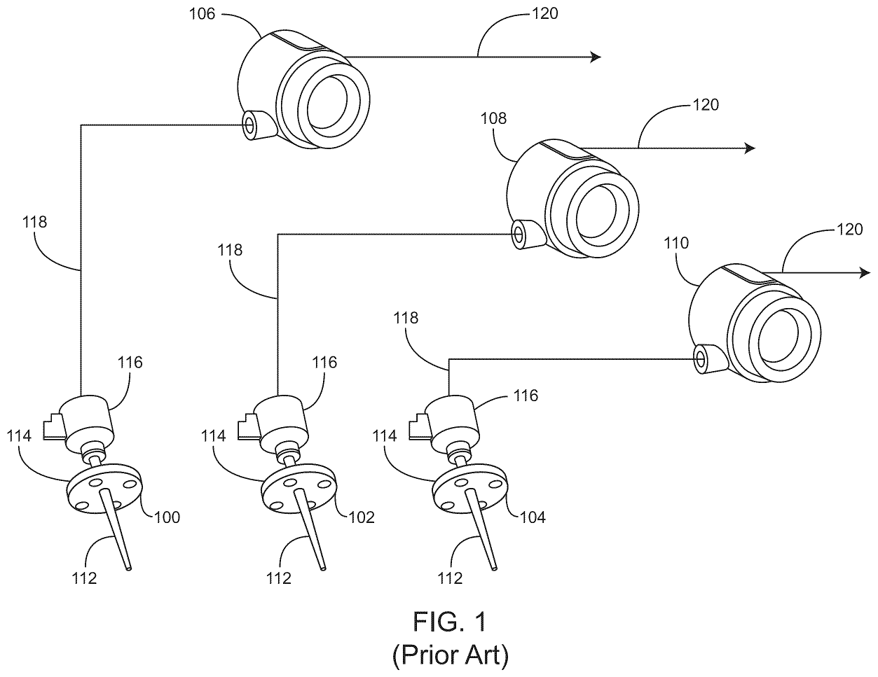

FIG. 1 is a diagrammatic view of triple redundant temperature measurement system in accordance with the prior art. As shown in FIG. 1, sensor assemblies housed into the three thermowells 100, 102, 104 are coupled to three respective temperature transmitters 106, 108, and 110. Each thermowell generally includes an elongated cylindrical probe 112 that is configured to be exposed to process fluid. As shown, each thermowell may also include a process mounting flange 114 such that flange 114 can mount to an associated or corresponding flange on process piping. However other types of process mounting, such as threaded connections and welded-in connections can also be used with thermowell and embodiments described below are applicable to all such process mounting techniques.

The triple redundant system illustrated in FIG. 1 requires three distinct process intrusions to mount the three distinct thermowells 100, 102, 104. Each sensor assembly generally includes an enclosure or junction box 116 from which wiring 118 couples to electronics within the respective temperature transmitters 106, 108, 110. Electronics within each temperature transmitter generally includes measurement circuitry configured to obtain an electrical indication relative to the temperature sensitive element of the temperature sensor assembly, processing circuitry that is configured to calculate a process temperature based on the measured signal, and communication circuitry that is configured to transmit the process fluid temperature signal to a control room as indicated diagrammatically at reference numerals 120.

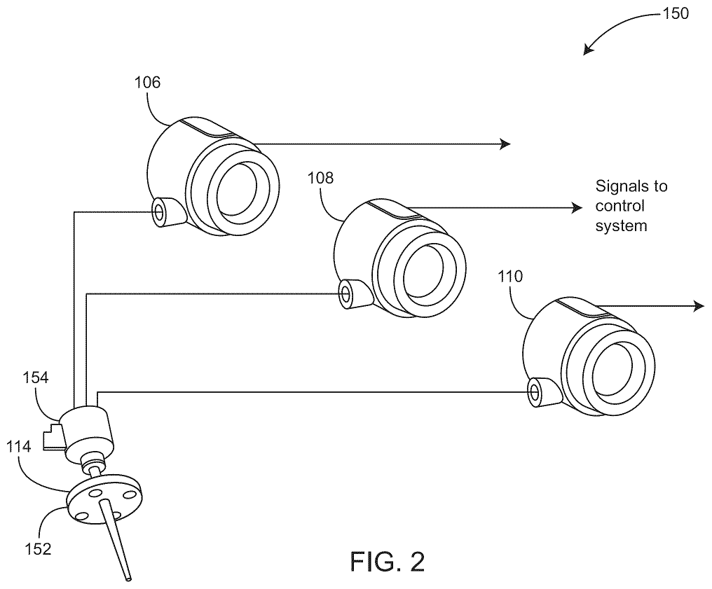

FIG. 2 is a diagrammatic view of a triple redundant process temperature sensing system in accordance with an embodiment of the present invention. System 150 includes a single thermowell 152 that is configured to house or mount a plurality of temperature sensor assemblies. As shown, thermowell 152 also includes a process mounting flange 114. However, since a single thermowell is used, only a single process intrusion is required to employ triple redundant temperature sensing system 150. As shown in FIG. 2, redundant sensors housed in a single thermowell 152 are coupled to an improved enclosure 154 which includes separate cable entries for cables of each temperature sensor assembly. Thus, three distinct temperature transmitters, 106, 108, and 110 can be coupled to respective temperature sensor assemblies disposed within single thermowell 152.

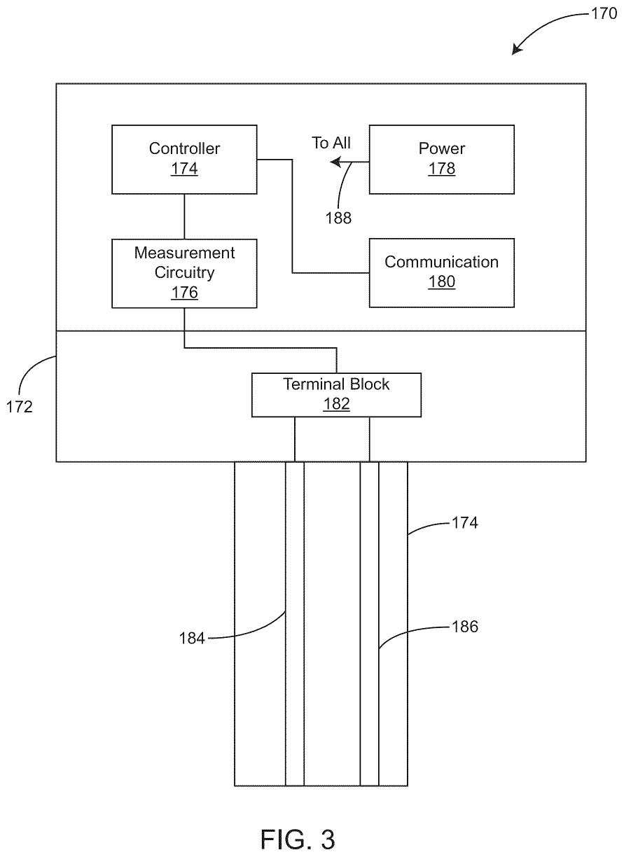

FIG. 3 is a block diagram of an improved process temperature measurement system in accordance with an embodiment of the present invention. System 170 generally includes an electronics enclosure 172 that contains a controller 174, measurement circuitry 176, power module 178, communication circuitry 180, and a terminal block 182. In the embodiment illustrated in FIG. 3, enclosure 172 is coupled directly to thermowell 174. However, those skilled in the art will recognize that enclosure 172 may be spaced from thermowell 174 and coupled thereto by suitable conductors. As shown in FIG. 3, thermowell 174 mounts a plurality of temperature sensor assemblies 184, 186. Each of temperature sensor assemblies 184, 186 is electrically coupled to measurement circuitry 176 via terminal block 182. Measurement circuitry 176 generally includes any suitable arrangement of electrical circuits that are able to engage each of temperature sensor assemblies 184, 186 to measure the temperature-sensitive electrical property thereof. Measurement circuitry 176 can include one or more analog-to-digital converters as well as suitable switching circuitry, such as a multiplexor. Additionally, measurement circuitry 176 can also include suitable linearization and/or amplification circuitry. Measurement circuitry 176 generally provides a digital indication of electrical properties of temperature sensor assemblies 184, 186 to controller 174. In one embodiment, controller 175 may be a microprocessor or microcontroller, or any other suitable circuitry that is able to receive the digital indications from measurement circuitry 176 and perform one or more suitable calculations to provide a process fluid temperature output.

Communication circuitry 180 is coupled to controller 174 and allows temperature measurement system 170 to communicate the process fluid temperature output over a process communication loop using a process communication loop protocol. Suitable examples of process communication loop protocols include the 4-20 mA protocol, HART®, FOUNDATION™ Fieldbus protocol, and WirelessHART (IEC 63591).

Temperature measurement system 170 also includes a power supply module 178 that provides power to all components of the systems indicated by arrow 188. In embodiments where the temperature measurement system is coupled to a wired process communication loop, such as a HART®, or a FOUNDATION™ Fieldbus process communication segment, power module 178 may include suitable circuitry to condition power received from the loop to operate the various components of system 170. Accordingly, in such wired process communication loop embodiments, power supply module 178 may provide suitable power conditioning to allow the entire device to be powered by the loop to which it is coupled. In other embodiments, when wireless process communication is used, power supply module 178 may include a source of power, such as a battery and suitable conditioning circuitry.

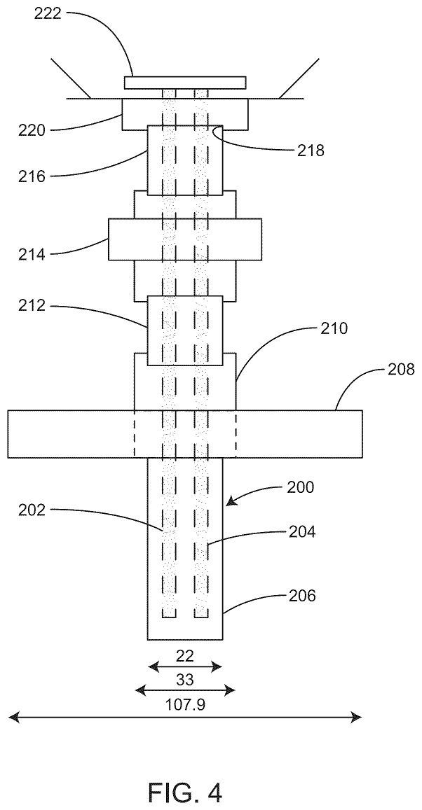

FIG. 4 is a diagrammatic cross-sectional view of an improved thermowell in accordance with an embodiment of the present invention. Thermowell 200 is generally configured to house a plurality of temperature sensor assemblies 202, 204 therein. A suitable thermowell can be used or otherwise modified in accordance with various embodiments described herein to accommodate multiple temperature sensor assemblies. For example, bar stock thermowells with flange process connections can be used for this purpose. Two or three bores or holes with a diameter sufficient to accommodate a 3 mm or 6 mm outside diameter temperature sensor assembly can be made in the thermowell, as required. While various descriptions and examples set forth below will provide certain dimensions, these are provided for illustrative purposes only, and are not intended to limit embodiments described herein.

In the embodiment illustrated in FIG. 4, thermowell 200 includes a cylindrical portion 206 having a diameter of approximately 22 mm that is affixed to process mounting flange 208. In one embodiment, cylindrical portion 206 may be welded to process mounting flange 208. In one example, process mounting flange 208 is a 1 inch ISO flange that includes a number of apertures through which mounting bolts may pass in order to mount the thermowell to process intrusion. Thermowell 200 also includes or is coupled to a 1 inch socket 210 that is internally threaded and configured to receive 1 inch nipple 212. As shown in FIG. 4, a 1 inch union 214 is employed to couple 1 inch nipple 212 to 1 inch nipple 216. As shown, 1 inch nipple 216 engages internally threaded aperture 218 of enclosure 220 to couple enclosure 220 to thermowell 200. Within enclosure 220, terminal block 222 receives individual conductors from the various temperature sensor assemblies 202, 204.

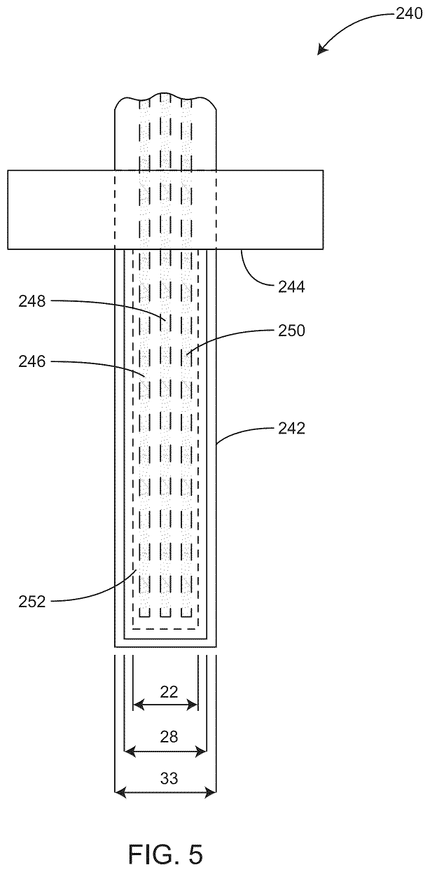

FIG. 5 is a diagrammatic cross-sectional view of a triple redundant temperature sensor thermowell assembly in accordance with an embodiment of the present invention. The embodiment shown in FIG. 5 is similar to that of FIG. 4 except that a pipe 242 is disposed around cylindrical member 252 and cylindrical member 252 accommodates three different temperature sensor assemblies 246, 248, and 250. Assembly 240 generally includes a pipe section 242 mounted to a process mounting flange 244. In the illustrated example, process mounting flange 244 is a 1 inch ANSI ISO flange however, any suitable process mounting flange can be employed. Process mounting flange 244 is sealingly coupled to pipe 242 such that when pipe 242 is exposed to process fluid, and flange 244 is mounted to a process, the process fluid is sealed within the process and does not leak at the process intrusion. In the illustrated example, pipe 242 has a 1 inch outer diameter. System 240 includes three distinct temperature sensor assemblies 246, 248, and 250. Each of temperature sensor assemblies 246, 248, and 250, in the illustrated example, has an outside diameter of 3 mm that is received within a bore of cylindrical member 252. Additionally, as shown in FIG. 5, cylindrical member 252 has a suitable outside diameter (illustrated as 22 mm) such that it can pass within the inner diameter (shown as 28 mm) of pipe 242. Cylindrical member 252 is preferably formed of a metal that is suitable for immersion in the process fluid (gas, liquid, or a combination). Certainly, those skilled in the art will recognize that variations can be made in these various dimensions in accordance with embodiments described herein.

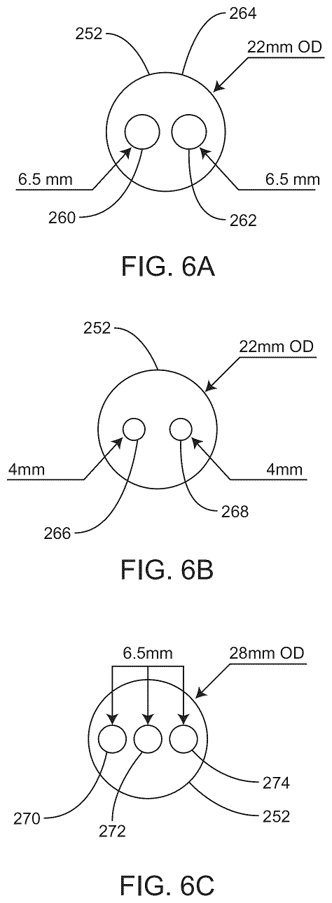

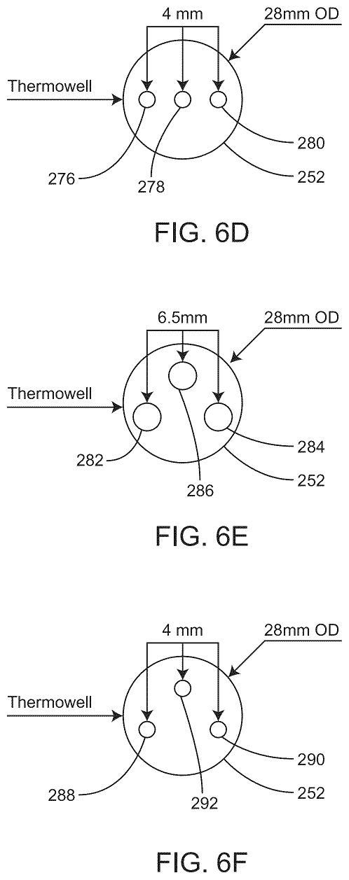

FIGS. 6A-6F show various top plan views of a cylindrical member configured to receive a plurality of temperature sensor assembly in a thermowell in accordance with embodiments described herein.

FIG. 6A depicts cylindrical member 252 having a pair of bores 260, 262 that each have a 6.5 mm inside diameter. As shown, each of bores 260, 262 is approximately equidistant from the center of cylindrical member 252. In this way, each of bores 260, 262 is spaced approximately the same distance from the outside diameter 264 of cylindrical member 252. This arrangement helps ensure consistency of measurement for the temperature sensor assemblies disposed within bores 260, 262.

FIG. 6B illustrates cylindrical member 252 with bores 266, 268 that each have inside diameters of 4 mm. These inside diameters are configured to receive 3 mm outside diameter temperature sensor assemblies. Also, as shown in FIG. 6B, the outside diameter of cylindrical member 252 is approximately 22 mm.

FIG. 6C is a top plan view of cylindrical member 252 illustrating three temperature sensor assembly bores 270, 272, and 274 each of which has a diameter of approximately 6.5 mm and is configured to receive a 6 mm outside diameter temperature sensor assembly. As shown in FIG. 6C, bore 272 is substantially centered within cylindrical member 252 while bores 270 and 274 are spaced virtually equidistant from bore 272. Additionally, in the example illustrated in FIG. 6C, cylindrical member 252 has an outside diameter of approximately 28 mm.

FIG. 6D is a top plan view of cylindrical member 252 shown with three temperature sensor assembly bores 276, 278, and 280. As can be seen, the arrangement of bores 276, 278, and 280 is similar to that shown in FIG. 6C. However, bores 276, 278, and 280 have smaller diameters than the bores shown in FIG. 6C. In the illustrated example, bores 276, 278, and 280 have approximately 4 mm diameter bores and are configured to receive 3 mm outside diameter-dimension temperature sensor assemblies.

FIG. 6E is a top plan view of cylindrical member 252 having three temperature sensor assembly bores 282, 284, and 286. As shown, bores 282, 284, and 286 have a diameter of approximately 6.5 mm and are sized to slidably receive temperature sensor assemblies having a 6 mm outside diameter. Additionally, as shown in FIG. 6E, each of bores 282, 284, and 286 are spaced substantially equidistant from the center of cylindrical member 252 and at approximately regular angular intervals (approximately) 120°.

FIG. 6F is a diagrammatic top plan view of cylindrical member 252 having three temperature sensor assembly bores 288, 290, and 292. The arrangement of bores 288, 290, and 292 is similar to that shown in FIG. 6E, however the diameter of bores 288, 290, and 292 is approximately 4 mm and is configured to receive 3 mm outside diameter temperature sensor assemblies.

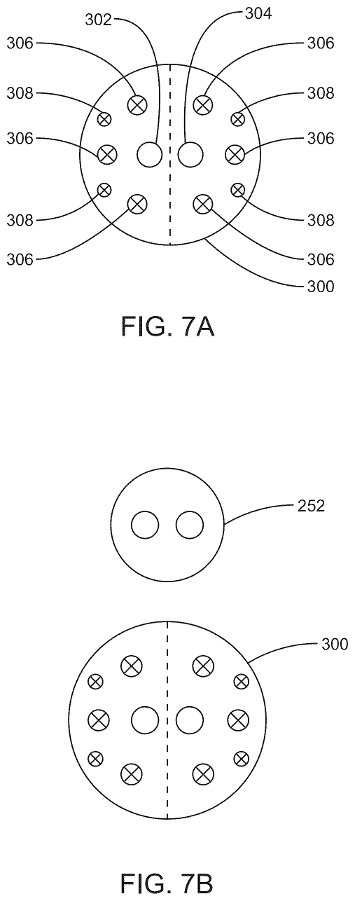

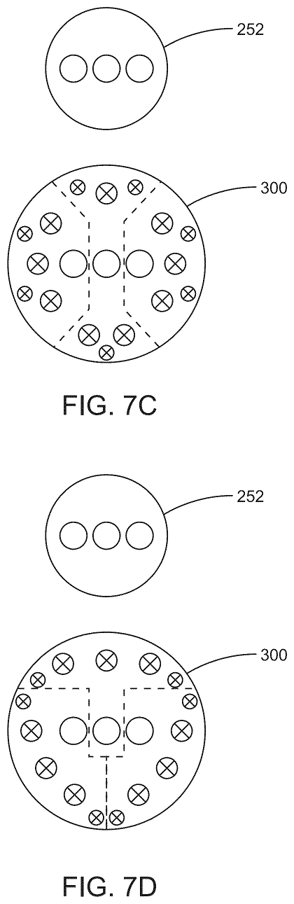

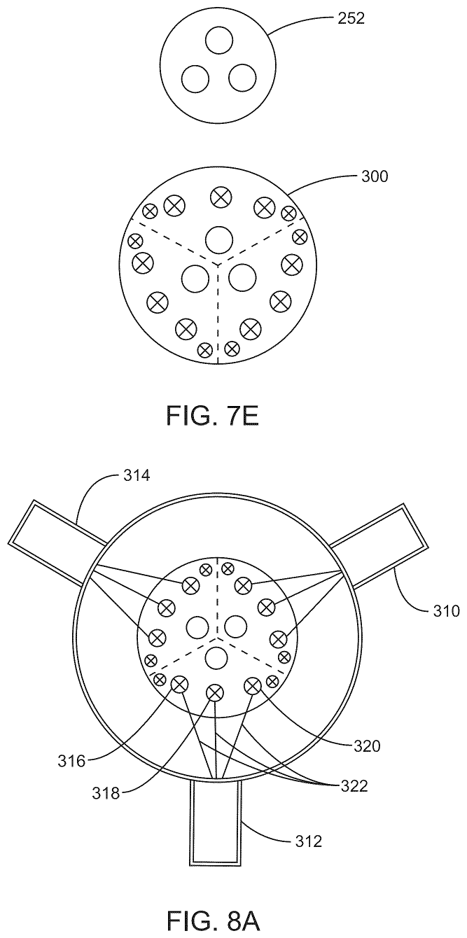

FIG. 7A is a diagrammatic view of an improved terminal block in accordance with an embodiment of the present invention. Generally, terminal blocks used with embodiments herein are modified to facilitate sliding of two/three, or more temperature sensor assemblies independently in the thermowell. This allows for the replacement of each temperature sensor assembly in case of failure. As shown in FIG. 7A, terminal block 300 includes a plurality of bores 302, 304 that are sized to allow temperature sensor assemblies to slide therethrough. Additionally, suitable terminals 306 are provided for each temperature sensor assembly. Additionally, a number of screws 308 are employed to mount the terminal block 300 within an enclosure.

FIGS. 7B-7E are intended to show various design alignments between thermowell cylindrical member 252, and bores for receiving temperature sensor assemblies, as well as the corresponding terminal block apertures to allow temperature sensor assemblies that are mounted within bores of the cylindrical member 252 to slide independently through the terminal block. While FIGS. 7B-7E illustrate the cylindrical member 252 above the terminal block 300, this is for illustration purposes, and in reality the cylindrical member 252 is disposed directly below the terminal block such that bores of the cylindrical member align with bores of the terminal block thereby allowing individual temperature sensor assemblies to be slidably removed and replaced, as desired.

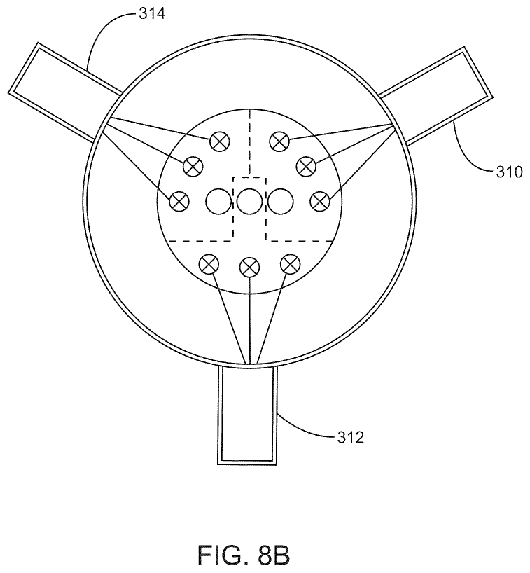

FIGS. 8A and 8B are diagrammatic top views illustrating an improved enclosure in accordance with an embodiment of the present invention. In some examples, the enclosure of the temperature sensor wiring is modified to allow three cable entries as well as for affixing or otherwise mounting the terminal block therein with screws. As shown in each of FIGS. 8A and 8B, three distinct cable entries 310, 312, and 314 are shown. Additionally, in the illustrated embodiments, the cable entries are angularly spaced approximately 120° apart. Further, as can be seen, each cable entry 310, 312, 314 is substantially aligned with various terminals for a selected one of three different temperature sensor assemblies. Specifically, referring to FIG. 8A, terminals 316, 318, and 320 are proximate cable entry 312 such that conductors 322 extending from terminals 316, 318, and 320 through cable entry 312 can do so directly and without necessarily crossing other conductors. This simplifies wiring and/or replacement tasks for a field technician. Note, while the various terminals are shown having three terminals for each temperature sensor, this is to support three-wire RTDs. Two wire RTDs as well as thermocouples will only require two terminals each.

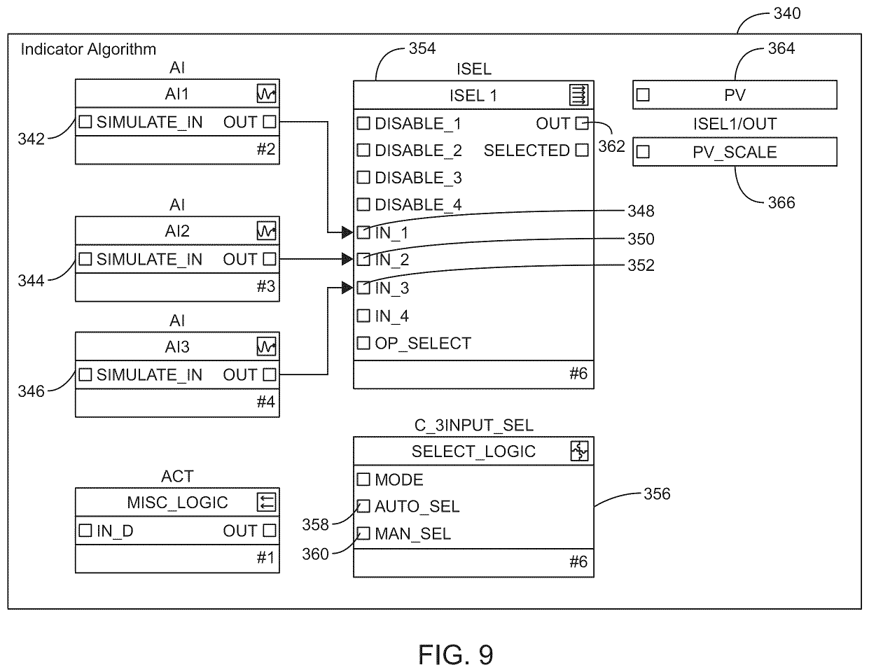

FIG. 9 is a diagrammatic view of logic for measurement of multiple process fluid temperature values using multiple temperature sensor assemblies in accordance with an embodiment of the present invention. Logic 340 may be embodied directly within controller 174 (shown in FIG. 3) or any other suitable logic device of the temperature transmitter. Analog inputs 342, 344, and 346 correspond to measured electrical characteristics of each of three distinct temperature sensor assemblies. As shown, each of the analog inputs 342, 344, and 346, is provided to respective inputs 348, 350, and 352 of logic block 354. Additionally, an input select block 356 is also provided where the mode of logic 340 can be selected between automatic 358, or manual 360. Logic block 354 provides an output 362 that is coupled to process variable out variable block 364 and may be adjusted based on process variable scale block 366. Logic 340 allows the controller to determine the process variable either by sending multiple independent signals relative to the individual temperature sensor assembly readings, and/or provide a combined temperature sensor measurement based on the combination of signals using suitable voting logic, weighting, or other appropriate programming techniques.

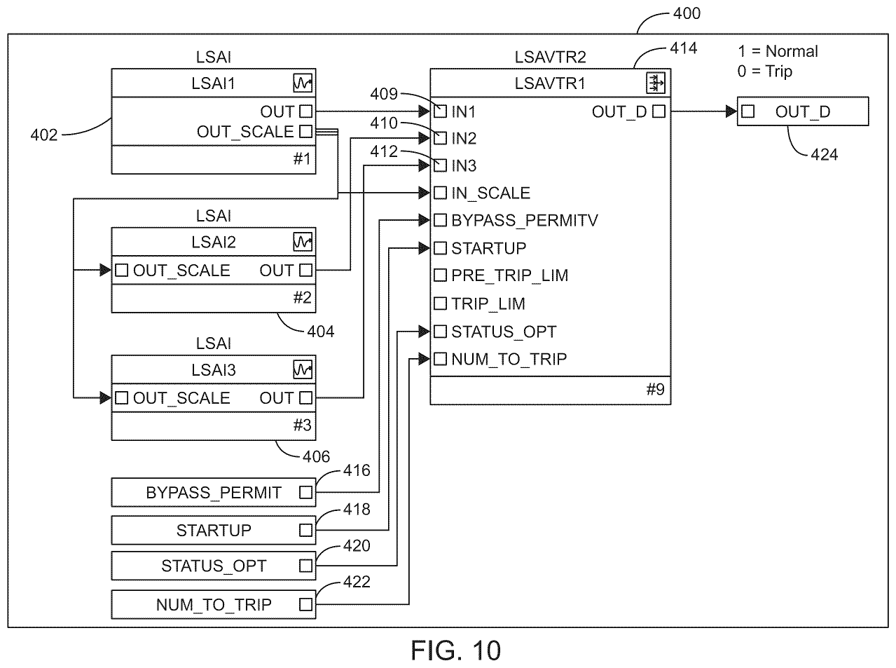

FIG. 10 is a logic diagram of a safety interlock in a safety instrumented system. Logic 400 includes three analog input blocks 402, 404, and 406. These analog inputs are provided to respective inputs 408, 410, and 412 of processing logic 414. Processing logic 414 may have additional inputs based upon system status, such as a bypass status 416, system startup status 418, an optional status 420, and a num_to_trip status 422. Based upon the analog inputs, and the one or more status inputs, processing logic 414 provides an output at logic block 424 that is indicative of the process temperature. This output may be a series of signals indicative of individual temperature sensor assembly readings, and/or a combination thereof.

Although the present invention has been described with reference to preferred embodiments, workers skilled in the art will recognize that changes may be made in form and detail without departing from the spirit and scope of the invention.

What is claimed is:

1. A thermowell comprising:
a process mount that is configured to mount to a process intrusion; and
a cylindrical member configured to be exposed to a process fluid, the cylindrical member having a plurality of bores extending therein, each bore being configured to receive a separate temperature sensor assembly.

2. The thermowell of claim 1, wherein the process mount includes a mounting flange coupled to the cylindrical member.

3. The thermowell of claim 1, wherein the cylindrical member is formed of metal.

4. The thermowell of claim 1, wherein the plurality of bores includes three distinct bores.

5. The thermowell of claim 1, wherein the plurality of bores are spaced equidistant from a center of the cylindrical member.

6. The thermowell of claim 1, wherein one of the plurality of bores is centered on a center of the cylindrical member.

7. The thermowell of claim 1, wherein the plurality of bores is spaced regularly from one another.

8. The thermowell of claim 1, and further comprising an enclosure coupled to the thermowell, the enclosure having a terminal block therein.

9. The thermowell of claim 8, wherein the terminal block includes a plurality of apertures, each aperture being configured to allow a temperature sensor assembly disposed in the thermowell to slide therethrough.

10. The thermowell of claim 8, wherein the enclosure includes a plurality of cable entries, each cable entry providing cabling for a respective temperature sensor assembly disposed within the thermowell.

11. The thermowell of claim 1, and further comprising a temperature sensor assembly disposed in each of the plurality of bores.

12. A redundant process temperature measurement system, the system comprising:
a thermowell including,
a process mount that is configured to mount to a process intrusion; and
a cylindrical member configured to be exposed to a process fluid, the cylindrical member having a plurality of bores extending therein, each bore containing a temperature sensor assembly,
a plurality of temperature transmitters, each temperature transmitter being operably coupled to a respective temperature sensor assembly, each temperature transmitter being configured to provide temperature measurement based on measurement of an electrical characteristic of the respective temperature sensor assembly.

13. The system of claim 12, wherein each temperature transmitter is operably coupled to the respective temperature sensor assembly via a terminal block.

14. The system of claim 13, wherein the terminal block includes a plurality of apertures therethrough, each aperture being configured to slidably pass a respective temperature sensor assembly.

15. The system of claim 12, wherein each temperature sensor assembly is formed of a temperature-sensitive element disposed within a metal sheath, and wherein the metal sheath is disposed within one of the plurality of bores.

16. The system of claim 12, wherein each temperature transmitter includes an electronics housing that contains:
measurement circuitry operably coupled to each of the temperature sensor assemblies.

17. The system of claim 16, wherein the electronics housing is spaced from the thermowell.

18. The system of claim 12, wherein the plurality of bores includes 3 bores in the cylindrical member.
